(19) United States
(12) Patent Application Publication
(10) Pub. No.: US 2008/0112424 A1
(43) Pub. Date: May 15, 2008

(54) Apparatus for reducing contention in prioritized contention access of wireless personal area network and method of using the same

(75) Inventors: Yong Suk Kim, Yongin-si (KR); Jun Seo Lee, Yongin-si (KR); Chang Woo Seo, Yongin-si (KR); Jun Haeng Cho, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/727,907

(22) Filed: Mar. 29, 2007

(30) Foreign Application Priority Data
Nov. 15, 2006 (KR) 10-2006-0112681

(51) Int. Cl. H04L 12/28

(52) U.S. Cl. 370/414

(57) ABSTRACT

A contention reduction apparatus and method in a prioritized contention access (PCA) method of a Wireless Personal Area Network are provided. A contention reduction apparatus of a Wireless Personal Area Network includes: a prioritized contention access (PCA) section retriever which retrieves a PCA section from beacons received for a beacon period (BP); a PCA section divider which divides the retrieved PCA section; a device selector which selects devices using the PCA section; and a PCA section allocator which allocates the divided PCA section to the selected devices.

### CROSS-REFERENCE TO RELATED APPLICATION

This application claims priority from Korean Patent Application No. 10-2006-0112681, filed on Nov. 15, 2006, in the Korean Intellectual Property Office, the entire disclosure of which is incorporated herein by reference.

### BACKGROUND OF THE INVENTION

1. Field of the Invention

Methods and apparatuses consistent with the present invention relate to contention reduction of a Wireless Personal Area Network, and more particularly, to a contention reduction apparatus and method in a Prioritized Contention Access (PCA) method of a Wireless Personal Area Network, which can reduce contention between devices in a PCA method of wireless multimedia medium access control (WiMedia MAC) corresponding to a Wireless Personal Area Network.

2. Description of Related Art

Generally, a beacon group corresponding to a Wireless Personal Area Network simply includes wireless multimedia medium access control (WiMedia MAC) devices without a coordinator controlling a device. Specifically, it is required that the devices included in the beacon group should retrieve, generate and maintain superframe synchronization.

A superframe includes a beacon period (BP) including a beacon with respect to the devices included in the beacon group, and a data period (DP) related to data transmission/reception.

The data transmission/reception between the devices is made in a distributed reservation protocol (DRP) method and a prioritized contention access (PCA) method.

According to the DRP method, a device receiving data determines a request permission, based on a reservation status in the beacon group, and a status of the device when a device transmitting data requests a reservation. Specifically, the DRP method corresponds to an uncompetitive method, and negotiates, in advance, a transmission amount for each traffic flow between a transmitting device and a receiving device.

According to the PCA method, devices compete in a transmission opportunity (TXOP) section, and a device obtaining a medium may transmit data. Specifically, the PCA method corresponds to a competitive method, and does not negotiate, in advance, a transmission amount for each traffic flow between a transmitting device and a receiving device.

Similar to the description above, since the PCA method corresponds to the competitive method, contention between devices included in the beacon group is significantly concentrated at a starting point in time of a PCA section. Specifically, since devices capable of PCA compete every time the PCA section starts, an amount of contention becomes maximal at the starting point in time of the PCA section, however, the amount of contention decreases by random backoff after the starting point in time of the PCA section.

Also, since the contention between the devices is concentrated at the starting point in time of the PCA section, backoff of the devices is frequently generated. Accordingly, there is a problem that a predetermined bandwidth may be not efficiently used.

Therefore, an apparatus which can reduce contention between devices concentrated at a starting point in time of a PCA section is required.

### SUMMARY OF THE INVENTION

The present invention provides a contention reduction apparatus and method of dispersing contention between devices in a prioritized contention access (PCA) section.

The present invention also provides a contention reduction apparatus and method of evenly dispersing devices capable of PCA in PCA sections, thereby reducing contention between devices.

The present invention also provides a contention reduction apparatus and method of reducing contention between devices, thereby reducing an amount of unnecessary power consumption of the devices.

According to an aspect of the present invention, there is provided a contention reduction apparatus of a Wireless Personal Area Network including: a prioritized contention access (PCA) section retriever which retrieves a PCA section from beacons received for a beacon period (BP); a PCA section divider which divides the retrieved PCA section; a device selector which selects devices using the PCA section; and a PCA section allocator which allocates the divided PCA section to the selected devices.

In this instance, the PCA section retriever may retrieve the PCA section, based on distributed reservation protocol (DRP) information elements of the received beacons.

In this instance, the PCA section divider may divide a PCA section occupying a section greater than a predetermined transmission opportunity (TXOP) from the retrieved PCA section.

In this instance, the device selector may select devices including transmission traffic as devices using the PCA section.

In this instance, the PCA section allocator may allocate the divided PCA section, based on a priority order with respect to the selected devices.

In this instance, the PCA section allocator may establish a higher priority order for a device in which an access category of transmission traffic corresponds to a best effort (BE), than a device in which the access category of the transmission traffic corresponds to a background (BK), and allocate the divided PCA section to the device corresponding to the BE once more.

According to another aspect of the present invention, there is provided a contention reduction apparatus of a Wireless Personal Area Network including: a PCA section retriever which retrieves a PCA section from beacons received for a BP; a device selector which selects devices using the PCA section; and a PCA section allocator which allocates the retrieved PCA section to the selected devices.

According to still another aspect of the present invention, there is provided a contention reduction method of a Wireless Personal Area Network including: retrieving a PCA section from beacons received for a BP; dividing the retrieved PCA section; selecting devices using the PCA section; and allocating the divided PCA section to the selected devices.

In this instance, the dividing may divide a PCA section occupying a section greater than a predetermined TXOP from the retrieved PCA section.

According to yet another aspect of the present invention, there is provided a contention reduction method of a Wireless Personal Area Network including: retrieving a PCA section from beacons received for a BP; selecting devices using the PCA section; and allocating the retrieved PCA section to the selected devices.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating a configuration with respect to a contention reduction apparatus of a Wireless Personal Area Network according to an exemplary embodiment of the present invention;

FIG. 2 is a diagram illustrating a beacon group for describing the present invention;

FIG. 3 is a diagram illustrating a superframe transmitted to a device;

FIG. 4 is a diagram illustrating dividing a prioritized contention access (PCA) section according to an exemplary embodiment of the present invention;

FIG. 5 is a diagram illustrating allocating the divided PCA section to the selected devices according to an exemplary embodiment of the present invention;

FIG. 6 is a block diagram illustrating a configuration of a contention reduction apparatus of a Wireless Personal Area Network according to another exemplary embodiment of the present invention;

FIG. 7 is a flowchart illustrating an operation of a contention reduction method of a Wireless Personal Area Network according to an exemplary embodiment of the present invention; and

FIG. 8 is a flowchart illustrating an operation of a contention reduction method of a Wireless Personal Area Network according to another exemplary embodiment of the present invention.

### DETAILED DESCRIPTION OF EXEMPLARY EMBODIMENTS OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

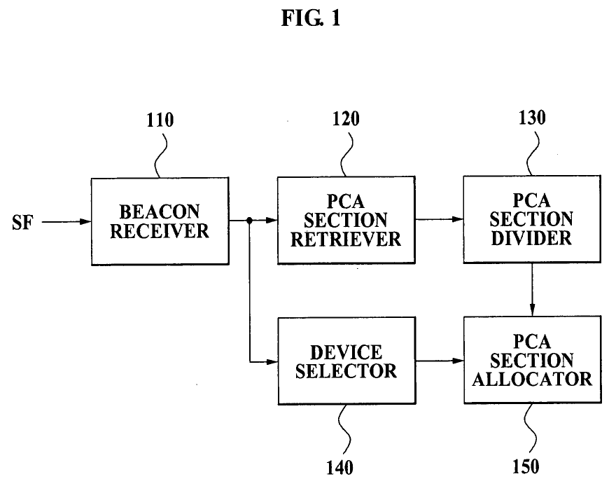

FIG. 1 is a block diagram illustrating a configuration with respect to a contention reduction apparatus of a Wireless Personal Area Network according to an exemplary embodiment of the present invention.

Referring to FIG. 1, the contention reduction apparatus of the Wireless Personal Area Network includes a beacon receiver 110, a prioritized contention access (PCA) section retriever 120, a PCA section divider 130, a device selector 140, and a PCA section allocator 150.

The beacon receiver 110 receives and outputs a superframe (SF) transmitted from another device included in a beacon group.

The PCA section retriever 120 retrieves a PCA section for a beacon period (BP) configuring the SF outputted from the beacon receiver 110.

In this instance, the PCA section retriever 120 may retrieve the PCA section, based on distributed reservation protocol (DRP) information elements of beacons included in the BP.

In this instance, the PCA section retriever 120 may retrieve, as the PCA section, sections where a reservation type of the DRP information elements of the beacons corresponds to PCA.

In this instance, the PCA section retriever 120 may store the retrieved PCA sections in a table.

The PCA section divider 130 may divide the PCA section retrieved by the PCA section retriever 120.

In this instance, the PCA section divider 130 may use the PCA section as is without dividing the PCA section retrieved by the PCA section retriever 120.

In this instance, the PCA section divider 130 may further divide the PCA section retrieved by the PCA section retriever 120, and use the divided PCA section. Here, the PCA section divider 130 may further divide the retrieved PCA section when the retrieved PCA section occupies a section greater than a predetermined transmission opportunity (TXOP).

In this instance, the PCA section divider 130 may store the divided PCA section in a table.

The device selector 140 selects devices using the PCA section divided by the PCA section divider 130.

In this instance, the device selector 140 selects the devices using the divided PCA section, based on the BP configuring the SF outputted from the beacon receiver 110.

In this instance, the device selector 140 may select devices including transmission traffic as the devices using the divided PCA section, based on the beacons included in the BP.

In this instance, the device selector 140 may determine devices including traffic indication map (TIM) information in the SF as the devices including transmission traffic, and select the devices including the TIM information as the devices using the PCA section.

In this instance, the device selector 140 may select all devices included in the beacon group as the devices using the PCA section.

The PCA section allocator 150 allocates the PCA section divided by the PCA section divider 130 to the devices selected by the device selector 140.

In this instance, the PCA section allocator 150 may sequentially allocate the divided PCA section to the selected devices.

In this instance, the PCA section allocator 150 may allocate the divided PCA section to the selected devices, based on a priority order with respect to transmission traffic.

Here, the PCA section allocator 150 may establish a higher priority order for a device in which an access category of transmission traffic corresponds to a best effort (BE), than a device in which the access category of the transmission traffic corresponds to a background (BK), and allocate the divided PCA section to the device in which the access category of the transmission traffic corresponds to the BE more than the device in which the access category of the transmission traffic corresponds to the BK. Specifically, when video (VI) or voice (VO) transmission traffic is transmitted to a DRP section, and BE or BK transmission traffic is transmitted to the PCA section, the PCA section allocator 150 may establish a higher priority order for the BE transmission traffic such as the Internet, and the like, than the BK transmission traffic, and allocate the divided PCA section to the device transmitting the BE transmission traffic greater than the device transmitting the BK transmission traffic.

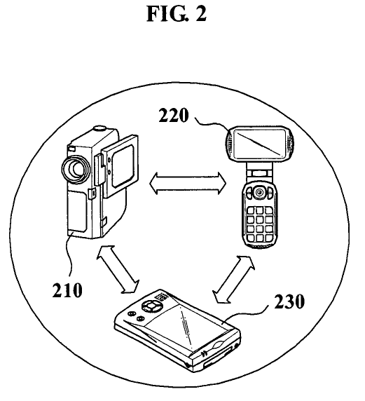

An operation of a contention reduction method of a Wireless Personal Area Network according to an exemplary embodiment of the present invention is described with reference to FIGS. 2 through 5.

FIG. 2 is a diagram illustrating a beacon group for describing an exemplary embodiment of the present invention.

Referring to FIG. 2, the beacon group includes a first device 210, a second device 220, and a third device 230.

In this instance, devices included in the beacon group may be a camcorder, a mobile phone, a personal digital assistant, and the like, and each device includes the contention reduction apparatus of the Wireless Personal Area Network illustrated in FIG. 1.

In each device included in the beacon group, the beacon receiver receives an SF transmitted from another device, and a PCA section retriever analyzes a BP of the received SF and retrieves the PCA section.

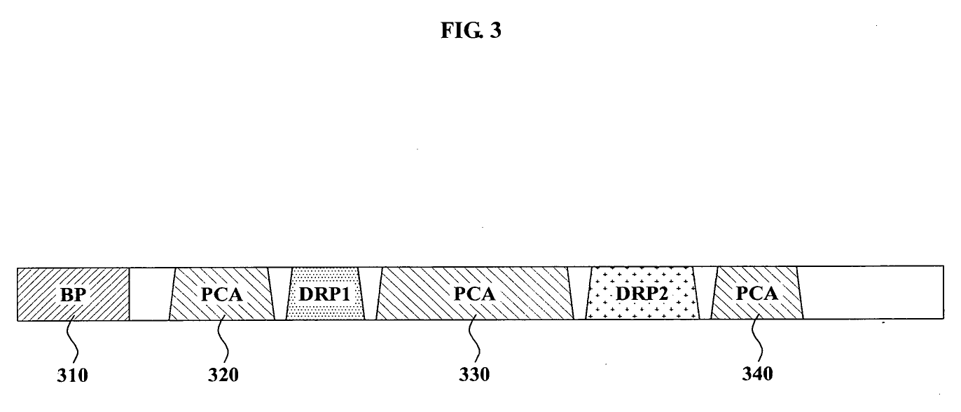

As an example, the PCA section retriever analyzes DRP information elements of the beacons included in the BP, and retrieves the PCA section, similar to an example illustrated in FIG. 3. In this instance, the PCA section indicates a section where a reservation type of the DRP information elements corresponds to PCA.

As illustrated in FIG. 3, it is obvious to those of ordinary skill in the art that the DRP information elements of beacons included in a BP 310 by the PCA section retriever are analyzed, and three PCA sections 320 through 340 are retrieved.

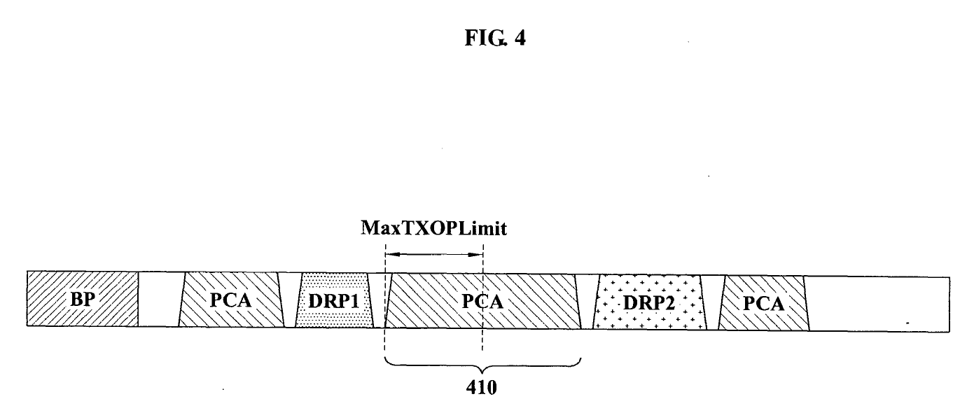

Similar to an example illustrated in FIG. 4, the PCA section divider divides a PCA section 410 occupying a section greater than a predetermined TXOP value (MaxTXOPLimit) from the retrieved PCA section into two PCA sections. Specifically, the PCA section divider performs a function of dividing a PCA section occupying a section greater than a predetermined value (MaxTXOPLimit), and increasing the number of the PCA sections which may be allocated to devices.

The device selector selects devices including transmission traffic using TIM information of the beacons included in the BP. Here, it is assumed that the first device and the second device from devices illustrated in FIG. 2 include the transmission traffic.

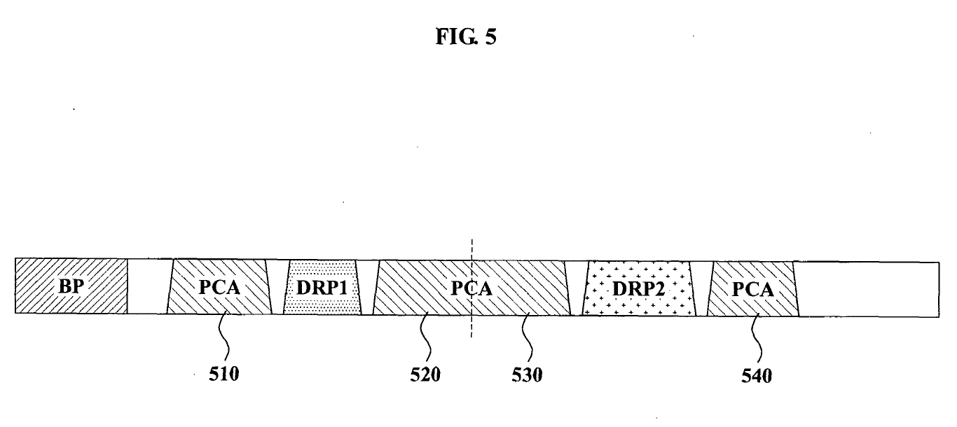

The PCA section allocator allocates the divided PCA section to the first device and the second device. For example, the PCA section allocator allocates the first divided PCA section 510 and the third divided PCA section 530 to the first device, and allocates the second divided PCA section 520 and the fourth divided PCA section 540 to the second device, as illustrated in FIG. 5.

In this instance, the PCA section allocator may variously allocate the divided PCA section according to a type of the transmission traffic of the selected devices.

Specifically, the PCA section allocator may allocate the divided PCA section to the device transmitting BE transmission traffic more than to the device transmitting BK transmission traffic. For example, when the first device transmits the BE transmission traffic, and the second device transmits the BK transmission traffic, the PCA section allocator allocates the first divided PCA section 510 and the second divided PCA section 520 to the first device, and allocates the third divided PCA section 530 to the second device. Accordingly, the first device transmits traffic via the first divided PCA section 510 and the second divided PCA section 520, and the second device transmits traffic via the third divided PCA section 530. Also, the PCA section allocator may allocate the fourth divided PCA section 530 to the first device.

Since the devices included in the beacon group transmit traffic to the other device via the PCA section allocated to each device by the PCA section allocator, contention between devices in the PCA section can be reduced.

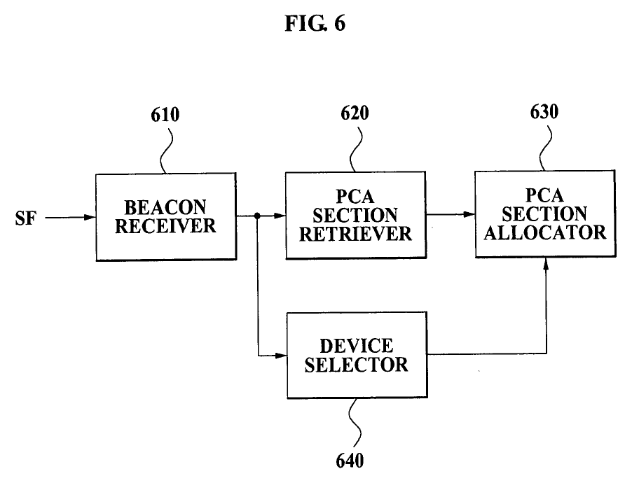

FIG. 6 is a block diagram illustrating a configuration of a contention reduction apparatus of a Wireless Personal Area Network according to another exemplary embodiment of the present invention.

Referring to FIG. 6, the contention reduction apparatus of the Wireless Personal Area Network includes a beacon receiver 610, a PCA section retriever 620, a device selector 640, and a PCA section allocator 630.

In this instance, since the beacon receiver 610, the PCA section retriever 620, and the device selector 640 perform the same functions as functions of the beacon receiver 110, the PCA section retriever 120, and the device selector 140 illustrated in FIG. 1 above, a more specific description with respect to the beacon receiver 610, the PCA section retriever 620, and the device selector 640 is omitted.

The PCA section allocator 630 allocates the PCA section retrieved by the PCA section retriever 620 to the devices selected by the device selector 640.

Specifically, FIG. 1 illustrates allocating the divided PCA section to the selected devices after dividing the retrieved PCA section, however, FIG. 6 illustrates allocating the retrieved PCA section to the selected devices without dividing the retrieved PCA section.

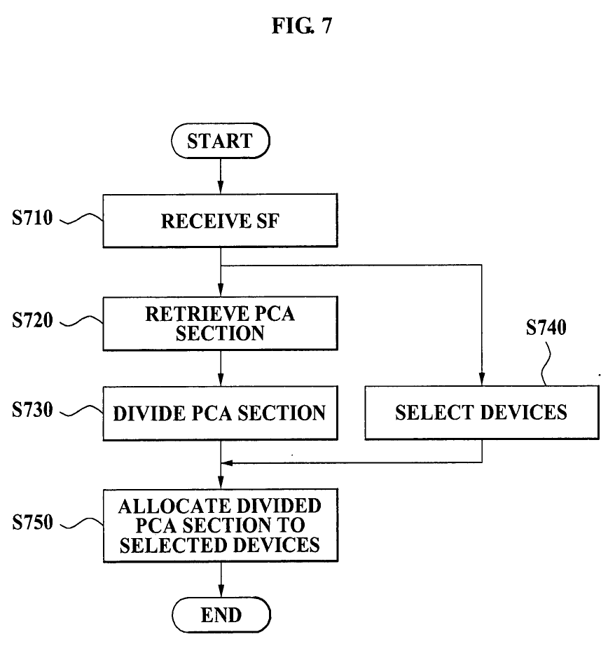

FIG. 7 is a flowchart illustrating an operation of a contention reduction method of a Wireless Personal Area Network according to an exemplary embodiment of the present invention.

Referring to FIG. 7, the contention reduction method of the Wireless Personal Area Network receives a SF (S710), and retrieves a PCA section, based on a BP of the received SF (S720).

Specifically, PCA sections where a reservation type of DRP information elements of beacons included in the BP corresponds to PCA are retrieved.

In this instance, the retrieved PCA sections may be stored by a table.

The contention reduction method of the Wireless Personal Area Network divides the retrieved PCA section in order to efficiently use the retrieved PCA section (S730).

In this instance, a PCA section occupying a section greater than a predetermined TXOP from the retrieved PCA section may be divided.

In this instance, the divided PCA section may be stored in a table.

The contention reduction method of the Wireless Personal Area Network selects devices using the divided PCA section (S740).

Specifically, devices including transmission traffic are selected as the devices using the PCA section, based on the beacons included in the BP. In this instance, the devices including the transmission traffic may be determined using TIM information of the beacons.

Although it is illustrated in FIG. 7 that operations S720 and S730 are simultaneously performed with operation S740, operation S740 may be performed before operation S720, or operation S740 may be performed after operation S730.

The contention reduction method of the Wireless Personal Area Network allocates the divided PCA section to the selected devices in order to reduce contention between devices in the PCA section (S750).

In this instance, the divided PCA section may be sequentially allocated to the selected devices.

In this instance, the divided PCA section may be allocated to the selected devices, based on a priority order with respect to the transmission traffic of the selected devices.

For example, when a priority order for a device in which an access category of transmission traffic corresponds to a BE is higher than a device in which the access category of the transmission traffic corresponds to a BK, the divided PCA section may be allocated to the device in which the access category of the transmission traffic corresponds to the BE more than to the device in which the access category of the transmission traffic corresponds to the BK.

Similar to the description above, the present invention can divide a PCA section, allocate the divided PCA section to devices including transmission traffic, and reduce contention between devices, thereby reducing an amount of unnecessary power consumption of the devices.

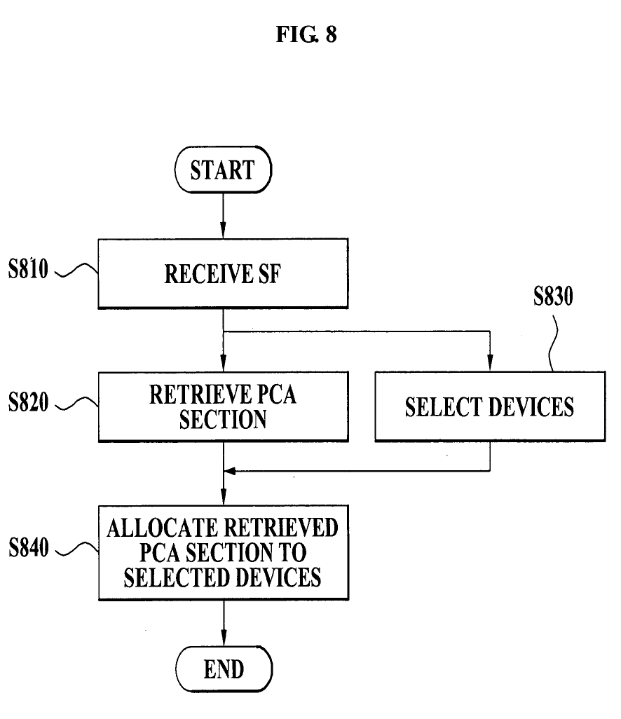

FIG. 8 is a flowchart illustrating an operation of a contention reduction method of a Wireless Personal Area Network according to another exemplary embodiment of the present invention.

Referring to FIG. 8, the contention reduction method of the Wireless Personal Area Network receives a SF (S810), and retrieves a PCA section, based on a BP of the received SF (S820).

Specifically, sections where a reservation type of DRP information elements of the beacons included in the BP corresponds to PCA are retrieved.

In this instance, the retrieved PCA sections may be stored in a table.

The contention reduction method of the Wireless Personal Area Network selects devices using the retrieved PCA section (S830).

Specifically, devices including transmission traffic may be selected as the devices using the PCA section, based on the beacons included in the BP. In this instance, the devices including the transmission traffic may be determined using TIM information of the beacons.

Although it is illustrated in FIG. 8 that operation S820 and operation S830 are simultaneously performed, operation S830 may be performed before operation S820, or operation S830 may be performed after operation S820.

The contention reduction method of the Wireless Personal Area Network allocates the retrieved PCA section to the selected devices in order to reduce contention between devices in the PCA section (S840).

The contention reduction method of the Wireless Personal Area Network according to the above-described exemplary embodiment of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to an exemplary embodiment of the present invention, there is provided a contention reduction apparatus and method of the Wireless Personal Area Network, which can disperse contention between devices in a PCA section.

According to another exemplary embodiment of the present invention, there is also provided a contention reduction apparatus and method of the Wireless Personal Area Network, which can evenly disperse devices capable of PCA in PCA sections, thereby reducing contention between devices.

According to yet another exemplary embodiment of the present invention, there is also provided a contention reduction apparatus and method of the Wireless Personal Area Network, which can reduce contention between devices, thereby reducing an amount of unnecessary power consumption of the devices.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A contention reduction apparatus of a Wireless Personal Area Network comprising:
a prioritized contention access (PCA) section retriever which retrieves a PCA section from beacons received for a beacon period (BP);
a PCA section divider which divides the retrieved PCA section;
a device selector which selects devices using the PCA section; and
a PCA section allocator which allocates the divided PCA section to the selected devices.

2. The contention reduction apparatus of claim 1, wherein the PCA section retriever retrieves the PCA section, based on distributed reservation protocol (DRP) information elements of the received beacons.

3. The contention reduction apparatus of claim 1, wherein the PCA section divider divides a PCA section occupying a section greater than a predetermined transmission opportunity (TXOP) from the retrieved PCA section.

4. The contention reduction apparatus of claim 1, wherein the device selector selects devices including transmission traffic as devices using the PCA section.

5. The contention reduction apparatus of claim 1, wherein the PCA section allocator allocates the divided PCA section, based on a priority order with respect to the selected devices.

6. The contention reduction apparatus of claim 5, wherein the PCA section allocator establishes a higher priority order for a device in which an access category of transmission traffic corresponds to a best effort (BE), than a device in which the access category of the transmission traffic corresponds to a background (BK), and allocates the divided PCA section to the device corresponding to the BE once more.

7. A contention reduction apparatus of a Wireless Personal Area Network comprising:
a prioritized contention access (PCA) section retriever which retrieves a PCA section from beacons received for a beacon period (BP);
a device selector which selects devices using the PCA section; and
a PCA section allocator which allocates the retrieved PCA section to the selected devices.

8. A contention reduction method of a Wireless Personal Area Network, said method comprising:
retrieving a prioritized contention access (PCA) section from beacons received for a beacon period (BP);
dividing the retrieved PCA section;
selecting devices using the PCA section; and
allocating the divided PCA section to the selected devices.

9. The method of claim 8, wherein the retrieving of the PCA section is based on distributed reservation protocol (DRP) information elements of the received beacons.

10. The method of claim 8, wherein the dividing operation comprises dividing a PCA section occupying a section greater than a predetermined TXOP from the retrieved PCA section.

11. The method of claim 8, wherein the selecting operation comprises selecting devices including transmission traffic as the devices using the PCA section.

12. The method of claim 8, wherein the allocating operation comprises allocating the divided PCA section, based on a priority order with respect to the selected devices.

13. The method of claim 12, wherein the allocating operation comprises establishing a higher priority order for a device in which an access category of transmission traffic corresponds to a best effort (BE), than for a device in which the access category of the transmission traffic corresponds to a background (BK), and allocating the divided PCA section to the device corresponding to the BE more than to the device corresponding to the BK.

14. A contention reduction method of a Wireless Personal Area Network comprising:
retrieving a prioritized contention access (PCA) section from beacons received for a beacon period (BP);
selecting devices using the PCA section; and
allocating the retrieved PCA section to the selected devices.

15. A computer-readable recording medium storing a program for implementing the method according to claim 8.
